(19) United States
(12) Patent Application Publication
(10) Pub. No.: US 2004/0109030 A1
(43) Pub. Date: Jun. 10, 2004

(54) Adaptive timing and adaptive content for graphical user interfaces

(75) Inventors: Shannon Matthew Farrington, Gilroy, CA (US); Chenhong Xia, San Jose, CA (US)

Correspondence Address: SUGHRUE MION, PLLC, 2100 PENNSYLVANIA AVENUE, N.W., SUITE 800, WASHINGTON, DC, 20037, US

(73) Assignee: International Business Machines Corporation, Armonk, NY (US)

(21) Appl. No.: 10/314,329

(22) Filed: Dec. 9, 2002

(51) Int. Cl. G09G 5/00

(52) U.S. Cl. 345/808

(57) ABSTRACT

Infopop onset times (i.e., delay times) and infopop content are dynamically adapted based upon the past behavior and experience level of an individual user. On an individual-user basis, the number of times an infopop has been shown to a user is monitored as well as how long the infopop stayed visible for the user each time the infopop was presented on a graphical user interface (GUI). The information collected as the result of such monitoring is stored, thereby establishing a user behavior profile. This user behavior profile is periodically assessed and is used as the basis for calculating individual infopop onset times and determining the content to be presented in subsequent infopop displays based upon the usage pattern established for each individual infopop and the expertise of the user with respect to specific issues addressed by an individual infopop or group of infopops.

### BACKGROUND OF THE INVENTION

1. Field of the Invention

The invention relates to graphical user interfaces used in computer displays. More particularly, it relates to new techniques for dynamically creating information popup displays within a graphical user interface (GUI), each popup capable of supporting user specific adaptive display onset times and user specific adaptive display content.

2. Description of the Related Art

An information popup, hereinafter infopop, is a user interface element that helps users of a computer's graphical user interface (GUI) understand concepts and finish tasks. An infopop typically presents help information related to a particular object appearing on the GUI. Infopop information usually appears in a multi-line, read-only text box. Infopops can be set to appear if a user allows a cursor to remain over a feature, or component, displayed (i.e., presented) in a GUI for a certain time interval. In some GUI products, infopops can be invoked by pressing a key. Examples of infopops include “tooltip” and “balloon help” features used in several commercially available GUI based computer systems (such as MICROSOFT WINDOWS).

One of the problems with conventional infopops is that, although an infopop can appear for certain GUI structures, such as a listbox, dropdown list, combobox, or table displayed in the GUI, conventional infopops are not available for individual choices listed in those GUI structures.

Another problem with conventional infopops is that the conventional mechanisms for setting the operational characteristics of an infopop within a GUI only allow for a fixed, static, onset time before displaying the infopop. Infopop onset time is the time that a cursor must hover over a displayed GUI component before the infopop associated with the GUI component is displayed. Such static onset times are problematic because they cannot accommodate the changing needs of individual users. If an onset time is too short, users get annoyed by the display, or presentation, of infopops that they are not interested in viewing. If an onset time is too long, users may never have the chance to discover the existence of an infopop that could have been useful to them.

One conventional popup delay approach used in MICROSOFT WINDOWS sets the popup delay based upon the user-configurable double-click time, that is, the time between a user sequentially clicking a mouse button to select an object displayed on a GUI. For example, for a default double-click time of 500 ms, the initial, autopop and reshow onset times are 500 ms, 5000 ms, and 100 ms, respectively.

Another conventional popup delay approach, used by IBM's DB2®, employs a fixed time interval. With both of these conventional approaches, the onset time does not adapt to a user's learning process. For example, users tend to need more help when they are beginning to use a product, and less after they are more familiar with the product. New users may never discover the existence of an infopop if they move the mouse faster than the fixed onset time. When users become more experienced, however, they tend to no longer need help available to them via the infopop displays, and therefore tend to find the infopop displays popping up after a fixed time delay, annoying.

Yet another problem with infopop displays is that the information presented via the infopop is static. As a user becomes more experienced, the user continues to be presented with the same information rather than information tailored to the individual's skill level. Thus, a potentially very helpful infopop capability is rendered virtually useless to an experienced user because the information displayed within the infopop fails to accommodate the user's changing information needs.

There remains a strong need for infopop displays in which infopop onset time and infopop display content are capable of adapting to suit the learning process of individual users.

### SUMMARY OF THE INVENTION

Therefore, in light of the above, and for other reasons that will become apparent when the invention is fully described, methods and apparatus for dynamically adapting infopop onset time and content based upon the past behavior and experience level of an individual user are described here.

The conventional GUI is enhanced to monitor, on an individual-user basis, how many times an infopop has been shown to the user and how long the infopop stayed visible for the user each time the infopop was presented. The information collected as the result of such monitoring is stored, thereby establishing an infopop user behavioral profile. This infopop user behavioral profile is periodically assessed and is used as the basis for calculating individual infopop delays for each individual infopop, based upon the usage pattern established for each individual infopop. A user's infopop behavioral profile is also periodically reassessed with respect to the user's level of expertise with respect to specific functions of the GUI that are addressed by individual infopops and/or groups of infopops. In addition, a user's behavioral profile can also be periodically reassessed with respect to the user's pattern of using other aspects of a GUI based product besides the infopop feature. Based upon the results of such assessments, the content presented in subsequent infopop displays is updated to reflect the established level of expertise associated with the individual user. Consequentially, the infopop behavioral profile can be further integrated within a more general behavioral profile which summarizes the user's usage patterns with respect to multiple aspects of the GUI based product including infopop usage patterns. Such a general behavioral profile can be used to customize a GUI presented to the user based upon a user's expertise level with respect to usage patterns in addition to the user's infopop usage pattern.

Dynamically stored information is used to define infopops, monitor user infopop activity and to summarize user infopop activity in a user infopop behavioral profile. Such an approach allows infopop displays, with dynamic onset times and dynamic content, to be associated with any GUI static component, GUI popup component, and/or GUI popup subcomponent. The techniques described here can be used to build infopops for inclusion within a pre-compiled application and/or to build infopops using a third party application for use in conjunction with an existing pre-compiled application.

The above features and advantages of the invention will become apparent upon consideration of the following descriptions and descriptive figures of specific embodiments thereof. While these descriptions go into specific details of the invention, it should be understood that variations may and do exist and would be apparent to those skilled in the art based on the descriptions herein.

### BRIEF DESCRIPTION OF THE DRAWINGS

FIG. 1 is a non-limiting, representative system level block diagram of a computer system having a graphical user interface (GUI) that supports infopop displays with user specific adaptive infopop onset times and user specific adaptive infopop content based upon each user's monitored infopop usage.

FIG. 2 is a non-limiting, representative flow chart illustrating a process associated with monitoring user infopop usage, and adapting infopop onset times and infopop content based upon a user's behavioral profile.

FIG. 3 is a non-limiting, representative flow chart illustrating a process associated with determining infopop onset times and infopop content to be associated with a user, based upon a user's behavioral profile.

FIG. 4 is a non-limiting, representative example of an infopop associated with a menu item within a GUI dropdown menu or popup menu.

FIG. 5 is a non-limiting, representative example of an infopop associated with features of a GUI scrollable table.

FIG. 6 is a non-limiting, representative example of an infopop associated with features of a GUI listbox and dropdown list/combobox.

### DETAILED DESCRIPTION

The embodiments described below are described with reference to the above drawings, in which like reference numerals designate like components.

As previously described, an information popup, hereinafter infopop, is an information display area within a graphical user interface (GUI) that helps users of a computer's GUI understand concepts and finish tasks. An infopop typically presents help information related to a particular object appearing on the GUI. Infopops can be set to appear if a user allows a cursor to remain over a feature, or component, displayed (i.e., presented) in a GUI for a certain time interval. Infopop information usually appears in a multi-line, read-only information display area.

Described here is a GUI capable of adaptively setting a time delay (i.e., onset time) for controlling presentation of an infopop within the GUI. A GUI controller module is configured to control presentation of an infopop display instance within the GUI. A monitoring module receives information pertaining to presentation of an infopop display instance from the graphical user interface controller module. A data store module stores information pertaining to presentation of the infopop display instance received from the monitoring module. A processing module retrieves information pertaining to presentation of the infopop to a specific user from the data store module, calculates a time delay for the information display area for the specific user, and changes the content scheduled for presentation via the infopop to the specific user based upon content displayed by previous instances of the infopop to the specific user.

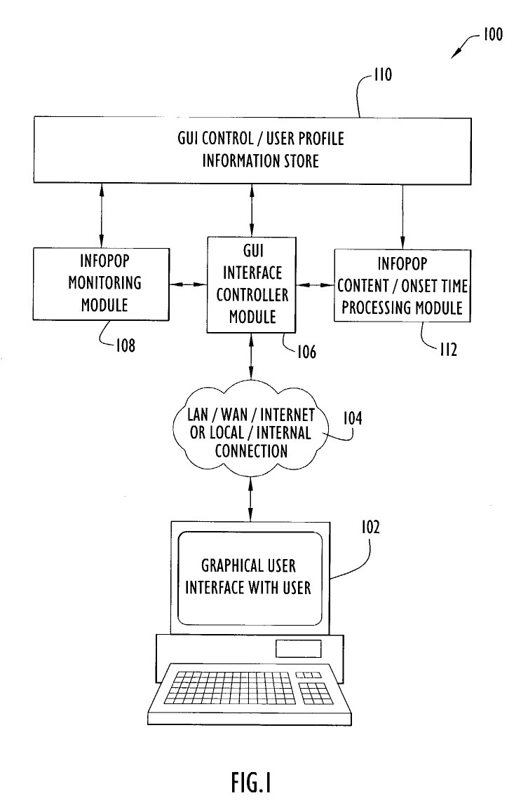

FIG. 1 depicts a non-limiting, representative system level diagram of a graphical user interface (GUI) coupled to a GUI interface controller module 106. The GUI interface controller module 106 typically will reside in a GUI client 102 with which a user interacts, although it may be coupled, via a local area network (LAN), wide area network (WAN), or Internet connection 104. The GUI interface controller module 106 is in communication with a GUI control/user profile information store 110, an infopop monitoring module 108, and an infopop content/onset time processing module 112.

The GUI interface controller module 106 controls the display of GUI components and processes user input received via the Local Area Network (LAN), Wide Area Network (WAN), Internet, or local/internal connection 104 from the GUI client 102. In one non-limiting, representative GUI interface controller module 106 embodiment, the GUI interface controller module 106 retrieves infopop onset times and user infopop content experience levels for a user from the GUI control/user profile information store 110 upon user login. These values are stored within the GUI control/user profile information store 110 or its sub-module, and is retrievable by the GUI interface controller module 106 and used to control the selection of infopop content and the presentation of infopops to the GUI client 102. In another non-limiting, representative embodiment, infopop content is stored in the GUI control/user profile information store 110 and the GUI interface controller module 106 retrieves infopop content from the GUI control/user profile information store 110 upon activating an infopop onset timer. When the infopop onset timer expires, the GUI displays an infopop containing the infopop text retrieved in response to the onset timer being activated.

In one non-limiting, representative embodiment, the GUI interface controller module 106 monitors user input via the GUI 102 by monitoring the position of a cursor or other selection device, and detects entry of the cursor within an infopop activation zone. Upon detection that the cursor has entered an infopop activation zone, the GUI interface controller module 106 activates an infopop onset timer based upon the user profile infopop onset time associated with the infopop/ infopop activation zone that has the cursor has entered and retrieves text, appropriate for the specific user, from the GUI control/user profile information store 110 in preparation of presenting the infopop text upon expiration of the infopop onset timer. If the cursor leaves the infopop activation zone prior to expiration of the onset timer, the onset timer is reset, the retrieved text is discarded, and the GUI interface controller module 106 returns to monitoring user input via the GUI, as described above.

The infopop monitoring module 108 monitors and records the presentation of infopops 10 displayed to each individual user by the GUI interface controller module 106. In one non-limiting, representative embodiment the infopop monitoring module 108 communicates with the GUI interface controller module 106 to receive an identifier for the current user, to receive notification of infopop activation (e.g., displaying an infopop upon the GUI display) and deactivation (e.g., terminating display of an infopop upon the GUI display) events. An infopop activation event notification message includes a user identifier, an infopop identifier and an indication of the user's experience level associated with the content the infopop presented to a user. An infopop deactivation event notification message includes a user identifier and the infopop identifier of the deactivated infopop.

The infopop monitoring module 108 assigns a timestamp to the respective infopop activation and deactivation events and communicates with the GUI control/user profile information store 110 to store, in association with the GUI user identifier and infopop identifier, an infopop activation time, an infopop deactivation time and an infopop content experience level indicator for each infopop presented to a user by the GUI interface controller module 106.

The infopop content/onset time processing module 112 calculates infopop onset times and assesses a user's experience level with respect to an individual infopop or group of related infopops. In one representative, non-limiting infopop content/onset time processing module 112 embodiment, the infopop content/onset time processing module 112 communicates with the GUI control/user profile information store 110 to retrieve information associated with a user and to calculate onset time periods and display content associated with infopops presented to a specific user. In response to a user logging in to the GUI system, the GUI interface controller module 106 informs the infopop content/onset time processing module 112 of the identity of the current user. The infopop content/onset time processing module 112 then requests infopop user profile records and infopop activity log records from the GUI control/user profile information store 110, calculates, based upon the infopop user profile records retrieved, onset times for each infopop, reassesses the user's experience level associated with each infopop or related group of infopops, and stores the updated onset times and experience levels in the GUI control/user profile information store 110 in association with the user.

In another infopop content/onset time processing module 112 embodiment, upon calculating and storing the infopop onset times and experience levels associated with a user, the infopop content/onset time processing module 112 sets a refresh timer. Upon expiration of the refresh timer, the infopop content/onset time processing module 112 requests infopop user profile records and infopop activity log records for the logged-on user from the GUI control/user profile information store 110, calculates onset times for each infopop defined in information store 110 based upon the infopop user profile records retrieved, reassesses the user's experience level associated with each infopop or related group of infopops based upon the user's prior infopop use, and stores the updated onset times and experience levels in the user profile. Upon completion of the refresh, the infopop content/onset time processing module 112 notifies the GUI interface controller module 106 that the onset times and content experience levels for the current user have been refreshed. In this manner the GUI interface controller module 106 is notified that it can refresh, from newly generated values stored in the GUI control/user profile information store 110, any user infopop onset times and/or user infopop content experience levels that the GUI interface controller module 106 has previously stored in its cache.

The GUI control/user profile information store 110 is an information storage resource accessible by the GUI interface controller module 106, the infopop monitoring module 108 and the content/onset time processing module 112, for information storage and retrieval. The GUI control/user profile information store 110 preferably is non-volatile, but may in addition cache a portion of frequently used information into the memory of the GUI interface controller module 106 for fast retrieval. In one non-limiting, representative embodiment, the GUI control/user profile information store 110 is implemented entirely in non-volatile disk storage such as a magnetic disk or a writable optical disk. In another non-limiting, representative embodiment, contents of a portion of the GUI control/user profile information store 110 is loaded from non-volatile disk storage into addressable memory allocated by the GUI interface controller module 106 at startup, and/or user login. Information relative to a specific user is saved to non-volatile storage periodically, or upon user logout, and/or as part of an application shutdown process.

The Local Area Network (LAN), Wide Area Network (WAN), Internet, or local/internal connection 104 that connects the GUI interface controller module 106 with a graphical user interface (GUT) client 102 includes any combination of physical and logical communication connections and transport/application level protocols that allow the GUI interface controller module 106 to interact with a user via a GUI interface and to present infopop displays in response to input from the user via the GUI interface. In one representative, non-limiting embodiment, both the GUI interface controller module 106 and the graphical user interface (GUT) client 102 reside on the same computer. In such an embodiment communication between the two modules can be implemented entirely via software executed by one or more CPU's available upon the computer and system resources made available to the CPU. In another non-limiting, representative embodiment, the GUI interface controller module 106 can reside on an application server serving GUI interfaces executing on multiple computers with connectivity to the GUI interface controller module 106 via a LAN. In such an embodiment, communication between the two modules can be implemented via any combination of application and network level communication protocols supported by the respective GUI client 102 and the application server upon which the GUI interface controller module 106 is executing. Likewise, in yet another representative, non-limiting environment, the GUI interface controller module 106 can reside on an application server accessible via a communication network that includes wide area network and/or Internet communication links. In such an embodiment, communication between the two modules can be implemented via any combination of application and network level communication protocols supported by the respective GUI client 102 and the application server upon which the GUI interface controller module 106 is executing, so long as such communications are compatible with and/or can be encapsulated in a manner that is compatible with any WAN or Internet communication links used to provide connectivity between the GUI client 102 and the application server upon which the GUI interface controller module 106 resides.

Table 1, below, presents non-limiting, representative information typically stored within an infopop activity log file stored by the infopop monitoring module 108 in the GUI control/user profile information store 110. As shown in Table 1, the infopop activity log records information about the display of an infopop display instance to a specific user. Such information can include: an identifier of the user to which the infopop was displayed (User_ID); an identifier of the infopop displayed (Infopop_ID); the user experience level of the infopop content displayed (Exp_Lvl); an infopop activation date (Date); an infopop activation time (Act_Time); an infopop deactivation time (Deact_Time); and a calculated infopop duration (Duration).

TABLE 1
Representative Infopop Activity Log

| User_ID | Infopop_ID | Exp_Lvl | Date | Act_Time | Deact_Time | Duration |
|---|---|---|---|---|---|---|
| tomr87 | find_text | 3 | Dec. 1, 2001 | 11:26:50 | 11:27:35 | 45 sec |
| janes43 | format_para | 1 | Dec. 1, 2001 | 11:27:30 | 11:28:00 | 30 sec |
| janes43 | find_text | 1 | Dec. 1, 2001 | 11:29:15 | 11:29:25 | 10 sec |
| jimh35 | find_text | 1 | Dec. 1, 2001 | 11:30:40 | 11:31:40 | 1 min |
| tomr87 | drw_picture | 2 | Dec. 1, 2001 | 11:34:05 | 11:34:10 | 5 sec |
| jimh35 | search_col | 1 | Dec. 1, 2001 | 11:34:30 | 11:35:00 | 30 sec |
| tomr87 | insert_pict | 1 | Dec. 1, 2001 | 11:37:25 | 11:37:40 | 15 sec |

As shown in the non-limiting, representative values presented in Table 1, an activity log record is saved for each infopop display instance that is displayed to each specific user, resulting in multiple infopop activity log records per user. Also shown in Table 1, an individual user can receive infopops with different experience levels. This is because a user may be associated with one experience level with respect to one group of infopops, such as infopops associated with graphics, or searching, yet be associated with another experience level with respect to another group of infopops, such as infopops associated with editing a table. The infopop activity log contains raw data that can be processed in order to ascertain user behavior characteristics, as described below.

Table 2, below, presents non-limiting, representative information typically stored within the GUI control/user profile information store 110 to identify and define infopop displays supported by a GUI. As shown in Table 2, an infopop definition table includes for each available infopop: an infopop identifier (Infopop_ID); the target user experience level of the infopop content (Exp_Lvl); an infopop group identifier (Grp_ID); text tailored to the experience level of the infopop (Infopop_Text); and an activation zone definition/coordinates for the infopop (Activation_Zone).

TABLE 2
Representative Infopop Definition Table

| | Exp_{—} | Grp_{—} | | Activation_{—} |
|---|---|---|---|---|
| Infopop_ID | Lvl | ID | Infopop_Text | Zone |
| find_text | 1 | 25 | Text for entry level user | Zone Def/ |
| | | | | Coords |
| find_text | 2 | 25 | Text for intermed level user | Zone Def/ |
| | | | | Coords |
| find_text | 3 | 25 | Text for experienced user | Zone Def/ |
| | | | | Coords |
| format_para | 1 | 25 | Text for entry level user | Zone Def/ |
| | | | | Coords |
| format_para | 2 | 25 | Text for intermed level user | Zone Def/ |
| | | | | Coords |
| format_para | 3 | 25 | Text for experienced user | Zone Def/ |
| | | | | Coords |
| search_col | 1 | 30 | Text for entry level user | Zone Def/ |
| | | | | Coords |
| search_col | 2 | 30 | Text for intermed level user | Zone Def/ |
| | | | | Coords |
| search_col | 3 | 30 | Text for experienced user | Zone Def/ |
| | | | | Coords |
| drw_picture | 1 | 35 | Text for entry level user | Zone Def/ |
| | | | | Coords |
| drw_picture | 2 | 35 | Text for intermed level user | Zone Def/ |
| | | | | Coords |
| drw_picture | 3 | 35 | Text for experienced user | Zone Def/ |
| | | | | Coords |
| insert_pict | 1 | 35 | Text for entry level user | Zone Def/ |
| | | | | Coords |
| insert_pict | 2 | 35 | Text for intermed level user | Zone Def/ |
| | | | | Coords |
| insert_pict | 3 | 35 | Text for experienced user | Zone Def/ |
| | | | | Coords |

As shown in the non-limiting, representative values presented in Table 2, at least one infopop definition table record is created for each infopop available for use by a GUI display. In Table 2, above, one record is shown for each unique Infopop_ID/Exp_Lvl combination, however such related records can be combined into a single record if a more complex definition table record is used.

“Exp_Lvl” used above, in Tables 1 and 2, identifies different levels of operational knowledge with respect to the features of a GUI based application. As indicated in Table 1, a user can possess one level of operational capability with respect to one set of application capabilities, yet possess another level of operational capability (either higher or lower) with respect to another set of application capabilities. In Table 2, a single infopop is provided with several infopop text options, depending upon the Exp_Lvl of the user for which the infopop is to be displayed.

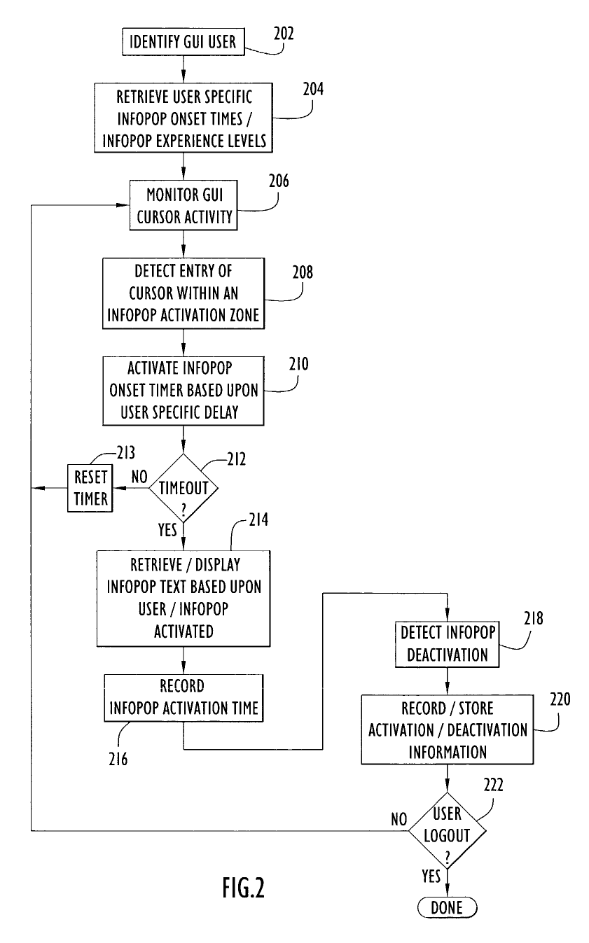

Infopop group identifiers (i.e., Grp_ID in Table 2) are used to associate infopops that contain similar or related content matter. For example, as shown in FIG. 2, infopops associated with text operations are associated with Grp_ID=25; infopops associated with table operations are associated with Grp_ID=30; and infopops associated with graphics operations are associated with Grp_ID=35. By including Grp_ID parameter in the infopop definition table (Table 2) and the user profile table (Table 3), a GUI application is provided the ability to deal with infopops individually, or as groups.

Defining infopop displays using a dynamic table, such as Table 2, allows infopops to be associated with any aspect of a GUI display, display component, or display subcomponent. Infopop components can be defined manually or with the help of an Integrated Development Environment (IDE). By way of example, using such an IDE, a user with access to the GUI display component object library associated with a preexisting application, or application under development, could tie infopop displays directly to GUI components/subcomponents using object based activation zones (i.e., an infopop display could be associated with an existing display component's operational characteristics via a object-oriented display component subclass). By way of a second example, an IDE user without code level access to existing GUI display components/subcomponents, can still add infopops to any component / subcomponent of an existing display by defining display coordinate based infopop activation zones.

Table 3, below, presents non-limiting, representative information typically stored within the GUI control/user profile information store 110 to summarize user specific infopop information. As shown in Table 3, an infopop user profile identifies for each user (User_ID)/infopop group (Infopop_Grp) combination, a calculated experience level (Calc_Exp_Lvl) and a calculated infopop onset time (Calc_Onset_Time), as determined by the infopop content/onset time processing module 112 based upon an assessment of values stored in the infopop activity log, a representative example of which is presented at Table 1. In another, non-limiting, representative embodiment, an experience level and infopop onset time can be calculated and stored for each user for each and every infopop available for display. Such an approach, however, requires additional user profile table storage space. In yet another embodiment, the user profile table stores calculated experience levels and calculated onset times only for those infopops or infopop groups for which the calculated experience level or calculated onset time differs from an assigned default value assigned the respective infopop or infopop group, thus significantly reducing user profile table storage space requirements associated with the two embodiments described directly above.

TABLE 3
Representative User Profile Table

| User_ID | Infopop_Grp | Calc_Exp_LvL | Calc_Onset_Time |
|---|---|---|---|
| janes43 | 25 | 1 | 500 ms |
| janes43 | 30 | 1 | 675 ms |
| janes43 | 35 | 1 | 575 ms |
| jimh35 | 25 | 1 | 500 ms |
| jimh35 | 30 | 3 | 900 ms |
| jimh35 | 35 | 2 | 700 ms |
| tomr87 | 25 | 3 | 1 sec |
| tomr87 | 30 | 3 | 1.3 sec |
| tomr87 | 35 | 3 | 1.7 sec |

FIG. 2 is a non-limiting, representative flow chart illustrating a process associated with monitoring user infopop usage, and adapting infopop onset times and infopop content based upon a user's behavioral profile. First, in operation 202, the GUI interface controller module identifies a GUI user via a user login or an access request via a previously established user session. Once a user is identified, the GUI interface controller module retrieves, in operation 204, user profile information stored in the GUI control / user profile information store containing user specific infopop onset times and infopop experience levels, as previously described with respect to Table 3.

Next, in operation 206, the GUI interface controller module monitors user input via the GUI by monitoring the position of a cursor or other selection device, and detects, in operation 208, entry of the cursor within an infopop activation zone, as described with respect to Table 2, above. Upon detection that the cursor has entered an infopop activation zone, the GUI interface controller module activates, in operation 210, an infopop onset timer based upon the user profile infopop onset time associated with the infopop/ infopop activation zone that has the cursor has entered. If, in operation 212, the cursor leaves the infopop activation zone prior to expiration of the onset timer, the onset timer is reset in operation 213, and the GUI interface controller module returns to monitoring user input via the GUI as addressed with respect to operation 206.

However, if the onset timer in operation 212 expires, that indicates that the cursor has remained over the activation zone for at least the amount of time specified in Table 2 for that particular infopop, for that particular user. Accordingly, the GUI interface controller module retrieves and displays via the GUI interface, in operation 214, infopop text from the GUI control/user profile information store, as described in relation to Table 2, appropriate for the infopop experience level of the user. The infopop monitoring module, in operation 216, upon being informed by the GUI interface control module of the infopop display instance and the identity of the user and the infopop activated in the infopop display instance, initiates a new infopop activity log record for the GUI interface and stores within the record the user identifier, infopop identifier, and experience level associated with the infopop text message displayed in the infopop display instance.

In response to the GUI interface controller detecting in operation 218 that the cursor has left the infopop activation zone, the infopop display instance is deactivated and the infopop monitoring module is informed of the user identifier and infopop identifier that was deactivated. The infopop monitoring module then in operation 220 records the deactivation time in the appropriate infopop activity log record for the user/infopop combination and stores the completed infopop activity log record within the GUI control / user profile information store as described with respect to Table 1. Upon deactivation of the infopop display, unless the user has logged out of the GUI session, as indicated in operation 222, the GUI interface controller module returns to monitoring user input via the GUI as described with respect to operation 206.

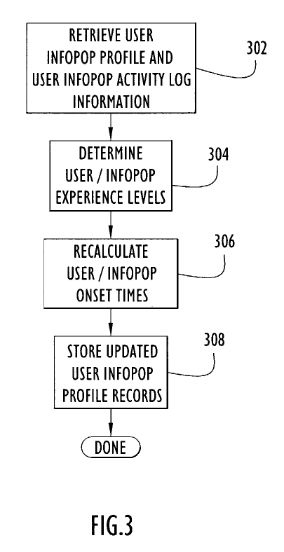

FIG. 3 is a non-limiting, representative flow chart illustrating a process for determining the infopop onset times and infopop content to be associated with a user based upon that user's behavioral profile. As described in relation to FIG. 1, the infopop content/onset time processing module 112 is responsible for calculating infopop onset times and for assessing a user's experience level with respect to an individual infopop or group of related infopops, based upon the user's past activity with that individual infopop or group of related infopops. As shown in operation 302, the infopop content/onset time processing module 112 communicates with the GUI control/user profile information store 110 to retrieve infopop user profile information and user infopop activity log information for a specific user that is logged onto the GUI client 102. Next, in operation 304, the infopop content/onset time processing module determines infopop/infopop group experience levels for the user, based upon previously stored user profile infopop experience level values and infopop activity log entries recorded since the last time the user's infopop profile was updated. Then, in operation 306, the infopop content/onset time processing module 112 calculates infopop/infopop group onset times, based upon previously stored user profile infopop onset times (described in relation to Table 3) and infopop activity log entries (described in relation to Table 1) recorded in the infopop activity log since the last time the user's infopop profile was updated. Once user/infopop/infopop group experience level and infopop/infopop group onset times have been updated, user profile records that have been changed are rewritten to the GUI control/user profile information store 110 in operation 308. Optionally, the GUI control/user profile information store can be instructed to delete activity log records that have been assessed by the infopop content/onset time processing module and summarized in the newly updated user/infopop/infopop group profile records.

In operation 304, determining user/infopop experience levels for storage in the user profile table (i.e., Table 1) can be performed in numerous ways. In one non-limiting, representative embodiment (in which the user profile table stores user experience levels on a user/infopop basis), a user's infopop activity records are reviewed to determine how often an individual infopop at a given experience level has been displayed. If the same infopop has been displayed more than a user/system configurable number of times, and a higher experience level exists, the user's user profile experience for the infopop is incremented. In another non-limiting, representative embodiment (in which the user profile table stores user experience levels on a user/infopop group basis), a user's infopop activity records are reviewed to determine how often infopops associated with a given infopop group have been displayed. If infopops associated with the same infopop group have been displayed more than a user/system configurable number of times, and a higher experience level exists, the user's user profile experience for the infopop group is incremented. In yet another non-limiting, representative embodiment, a user's infopop activity records are reviewed and if the average time that the user displays a particular infopop, or infopops associated with a particular infopop group, is below a user/system configurable threshold, and a higher experience level exists for the infopop or infopop group, the user's user profile level of experience for the infopop or infopop group is incremented. Conversely, if upon analysis of a user's infopop activity records it is determined that the user has not accessed an infopop or group of infopops for a period of time that exceeds a user/system configurable period of time, the user's user profile experience for the infopop or infopop group is decremented.

In addition, a user's behavioral profile can also be periodically reassessed with respect to the user's pattern of using other aspects of a GUI based product besides the infopop feature. Based upon the results of such assessments, the content presented in subsequent infopop displays is updated to reflect the established level of expertise associated with the individual user. Consequentially, the infopop behavioral profile can be further integrated within a more general behavioral profile which summarizes the user's usage patterns with respect to multiple aspects of the GUI based product including infopop usage patterns. Such a general behavioral profile can be used to customize a GUI presented to the user based upon a user's expertise level indicated by the behavioral profile with respect to usage patterns in addition to the user's infopop usage pattern.

In operation 306, calculating user onset times associated with individual infopops or groups of infopops for storage in the user profile table (i.e., Table 3) can be performed in numerous ways. In one non-limiting, representative embodiment the onset time is based upon an algorithm that is controlled by two primary factors: how many times the infopop (or infopop group) has been displayed to the user; and how long the infopop stayed visible for the user each time the infopop was presented.

The rationale for using such an algorithm is that users are more likely to need the infopop if they have taken a relatively long time reading the content lately. Assuming that the number of times that the infopop (or group of infopops) has been presented is n, and the time interval that the infopop had stayed visible before being deactivated is a set of t1, t2, . . . tn, the following represents an abstract of such an algorithm:

Onset time=F{n, T(t1, t2, . . . tn)} Eq. 1

In such an approach, statistical outliers, whose values are beyond a certain user/system configurable threshold of standard deviation, are discarded. Such a step protects the adaptive process from being skewed by accidental invocations of an infopop.

One non-limiting, representative example of an equation that could be used to implement the abstract algorithm expressed at Eq. 1, is:

DT_{Total}=DT_{Initial}+DT_{Adaptive} Eq. 2

wherein DT_{Total} is said time delay;

wherein DT_{Initial} is a configurable initial default onset time; and

wherein DT_{Adaptive} is a computed value based upon monitored information.

In such a non-limiting, representative DT_{Adaptive} can be computed using the equation

$${DT}_{Adaptive} = C * ( n * n / {\sum }_{i = 1}^{n} t ( i ) ) ; \qquad Eq . 3$$

wherein C, is a configurable value set based upon the complexity of the infopop (or infopop group) displayed;

wherein n, is the total number of instances the infopop (or members of an infopop group) has/have been displayed to a unique user via graphical user interface; and

wherein t(i), is the amount of time that the infopop (or members of an infopop group) have been displayed during each instance that the infopop (or members of an infopop group) was/were displayed to said unique user.

The non-limiting, representative algorithm embodiments, described above, are based upon the following non-limiting, representative factors: 1) Onset time is in proportion to the number of times that an infopop has already been presented. The rationale is that the more times that a user has read an infopop text, the less they will need to do so in the future. 2) Onset time is inversely proportional to the average time that the infopop has stayed visible. This consideration is included through the use of

$${\sum }_{i = 1}^{n} t ( i ) ,$$

represented in Eq. 3. The rationale is that on the average, the longer that the infopop has stayed visible for the user to read, the more likely the user will need to read it in the future. After a users becomes familiar with an infopop the user will tend to skip the infopop. The constant C is a user/system configurable factor used to adjust the GUI to a user's learning speed, which can be dependent upon the complexity of the related product. The more difficult it is to learn a product, for example, the smaller the value of C should be.

The above algorithms are non-limiting, representative examples of using user profile data to adaptively determine infopop onset time. Variations of such algorithms may be used to adaptively determine infopop onset time based upon prior user activities.

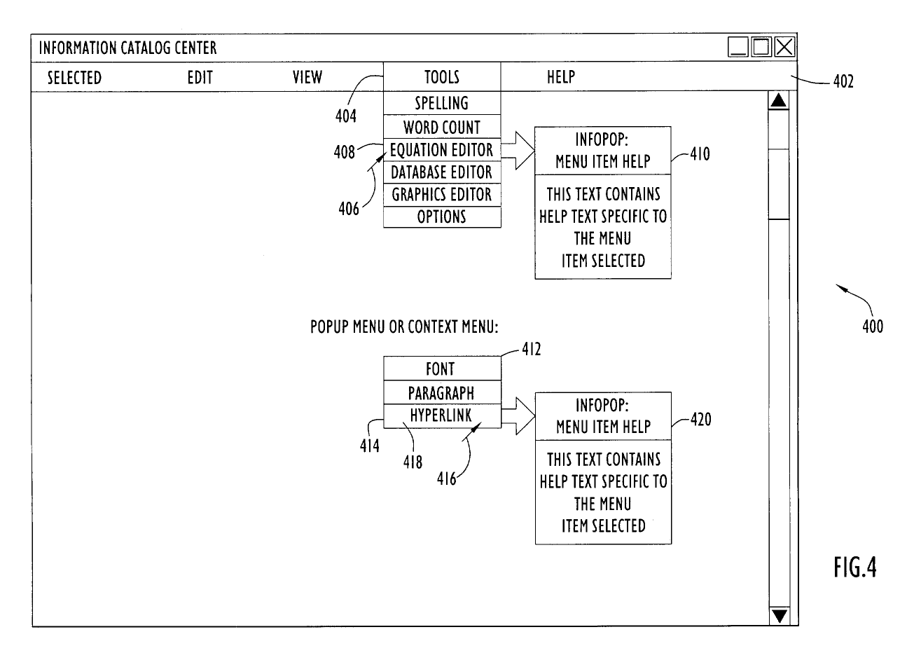

FIG. 4 is a non-limiting, representative example of an infopop associated with a selectable menu item within a GUI dropdown menu and a GUI popup menu. FIG. 4, depicts a representative, non-limiting GUI display 400 that includes a menu bar 402. The menu bar 402 includes selectable dropdown menus, such as the “Tools” dropdown menu 404. Clicking upon the tools dropdown menu results in the presentation of a dropdown menu that contains a list of individually selectable dropdown menu items. Furthermore, clicking upon a GUI object in the GUI display results in the presentation of a popup menu 412 that includes a list of individually selectable popup menu items. Such selectable dropdown menu items or selectable popup menu items in a conventional GUI display do not support infopop displays.

FIG. 4, however, depicts a representative, non-limiting infopop displayed in association with a selectable dropdown menu item 408 within a dropdown menu 404. Such an infopop capability is not supported by conventional GUI displays, however, the dropdown menu 404 shown in FIG. 4 is capable of being configured to present an infopop display 410 for a selectable dropdown menu item 408, as described with respect to Table 2. Placing the cursor 406 over a selectable dropdown menu item 408 for an adaptively determined onset time results in the presentation of an infopop display 410 with information relevant to the selectable dropdown menu item 408.

FIG. 4, also depicts a representative, non-limiting popup menu 412. For example, as in a conventional GUI display, right clicking upon a GUI object (not shown in FIG. 4) results in the presentation of a popup menu list 412 which includes multiple individually selectable popup menu items 414. The popup menu 412 shown in FIG. 4, is capable of being configured to present an infopop display for individually selectable popup menu items 414, as described with respect to Table 2. For example, placing the cursor 416 over a popup menu item 418 for an adaptively determined onset time results in the presentation of an infopop display 420 with information relevant to the popup menu item 418.

As previously described with regard to Table 2 and FIG. 3, the text displayed within an infopop display can be adaptively controlled based upon the experience level associated with the user to whom the infopop is displayed. Further, as previously described, the amount of time that the cursor must remain over an infopop activation zone is adaptively controlled based upon prior use of the infopop, including the number of times the infopop has been displayed and/or the length of time the infopop has been displayed, and/or the experience level of the user, as previously described. Furthermore, infopop displays can be associated with any aspect of a GUI display and/or GUI display popup and/or popup within a popup, simply by defining a new infopop record with an associated infopop activation zone, as previously described with respect to Table 2. Presentation, in FIG. 4, of an infopop in association with a selectable item within a dropdown menu 404 and popup menu 412 is merely representative.

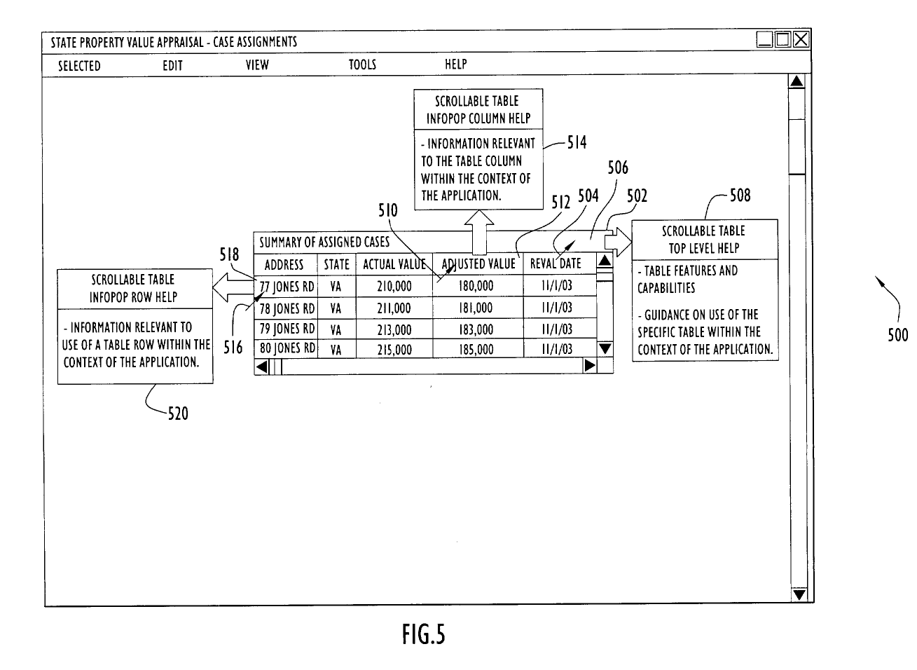

FIG. 5 is a non-limiting, representative example of infopops associated with components of a scrollable table within a GUI display. FIG. 5, depicts a representative, non-limiting GUI display 500 that includes scrollable table 502. The scrollable table 502 includes one or more table rows 518, and one or more table columns 512. FIG. 5, depicts three representative, non-limiting infopop displays, two of which are not supported by conventional GUI scrollable tables.

FIG. 5 depicts all three infopop displays as being presented simultaneously with the use of three separate cursors. Such a depiction is for convenience purposes, only. In an actual GUI display, each infopop would be individually displayed (i.e, without the simultaneous display of any other popup display) based upon the position of the single GUI cursor.

For example, in a conventional GUI display, placing the cursor over the scrollable table for an adaptively determined period of time can result in the presentation of an infopop display with information relevant to the scrollable table, as a whole, however, placing the cursor over a table column header 512 or upon a table row element 518 for an adaptively determined period of time does not result in the presentation of an infopop display with information relevant to the scrollable table column or scrollable table row.

FIG. 5 depicts representative infopop displays in association with features of a scrollable table not traditionally supported by popup displays. For example, as shown in FIG. 5, placing the cursor 510 over a table column header 512 for an adaptively determined period of time results in the presentation of an infopop display 514 with information relevant to the table column within the context of the GUI application. As further shown in FIG. 5, placing the cursor 516 over a table row field 518 for an adaptively determined period of time results in the presentation of an infopop display 520 with information relevant to the table row within the context of the GUI application.

As previously described with regard to Table 2 and FIG. 3, the text displayed within an infopop display can be adaptively controlled based upon the experience level associated with the user to whom the infopop is displayed. Further, as previously described, the amount of time that the cursor must remain over an infopop activation zone is adaptively controlled based upon prior use of the infopop, including the number of times the infopop has been displayed and/or the length of time the infopop has been displayed, and/or the experience level of the user, as previously described. Furthermore, infopop displays can be associated with any aspect of a GUI display and/or GUI display popup and/or popup within a popup, simply by defining a new infopop record with an associated infopop activation zone, as previously described in relation to Table 2. Presentation, in FIG. 5, of an infopop in association with a scrollable-table header, scrollable-table column header and scrollable-table row are merely representative.

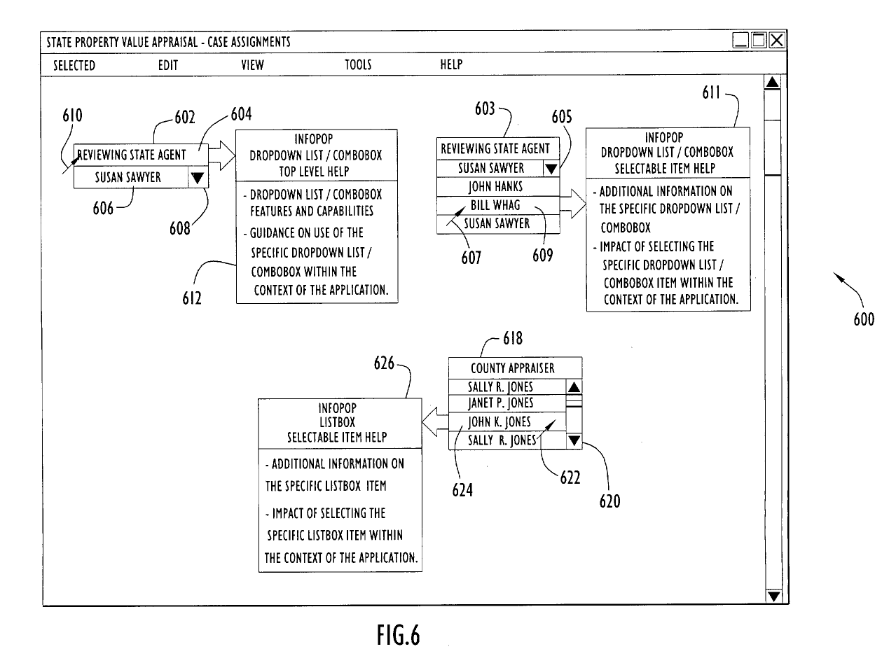

FIG. 6 is a non-limiting, representative example of infopops associated with components of a GUI listbox 618 and a dropdown list/combobox 602 within a GUI display. FIG. 6, depicts a representative, non-limiting GUI display 600 that includes a listbox 618 and a dropdown list/combobox 602. As shown with respect to the dropdown list/combobox 602, prior to activation, a dropdown list/combobox typically displays a static header 604, used to identify the content of the information displayed, and the currently selected active value 606, typically with an activation arrow button 608 directly adjacent to the displayed active value 606. Clicking upon the activation arrow 608 results in the presentation of a list of valid selections, as shown for convenience purposes only, with respect to a second representation of the dropdown list/combobox at 603.

In GUI display 600, placing a cursor 610 over a dropdown list / combobox 602 static header 604 for an adaptively determined period of time can result in the presentation of an infopop display 612 with information relevant to the dropdown list/combobox, as a whole. Also shown in FIG. 6, with respect to dropdown list / combobox 603, clicking on activation arrow 605 within dropdown list/combobox 603 results in the presentation of a list of individually selectable items. Placing the cursor 607 over a list item 609 for an adaptively determined period of time results in the presentation of an infopop display 611 with information relevant to the selectable item. Conventional dropdown lists/comboboxes do not support the presentation of an infopop display in association with dropdown list/combobox selectable items.

FIG. 6 also depicts a representative infopop display in association with features of a listbox 618 not supported by conventional listbox displays. For example, as shown in FIG. 6, placing the cursor 622 over a list item 624 within a listbox 618 for an adaptively determined period of time results in the presentation of an infopop display 626 with information relevant to the list item 624 within the context of the GUI application.

As previously described with regard to Table 2 and FIG. 3, the text displayed within an infopop display can be adaptively controlled, based upon the experience level associated with the user to whom the infopop is displayed. Further, as previously described, the amount of time that the cursor must remain over an infopop activation zone is adaptively controlled based upon prior use of the infopop, including the number of times the infopop has been displayed and/or the length of time the infopop has been displayed, and/or the experience level of the user, as previously described. Furthermore, infopop displays can be associated with any aspect of a GUI display and/or GUI display popup and/or popup within a popup, simply by defining a new infopop record with an associated infopop activation zone, as previously described in relation to Table 2. Presentation, in FIG. 6, of an infopop in association with a dropdown list/combobox and listbox are merely representative.

It will be appreciated that the embodiments described above and illustrated in the drawings represent only a few of the many ways of implementing a graphical user interface that employs infopops with adaptive infopop onset times and adaptive content.

The GUI interface with a user can be implemented by any quantity of any personal or other type of computer system (e.g., PC, APPLE, MACINTOSH, laptop, palm pilot, PDA, etc.). The computer systems of the present invention can include any commercially available operating system. These computer systems can further include commercially available or custom software (e.g., server software, browser software, etc.), and various types of input devices (e.g., keyboard, mouse, voice recognition, etc.). It is to be understood that the software for these computer systems can be implemented in virtually any desired computer language and can be developed by one of ordinary skill in the computer arts based on the descriptions contained here and the flow charts illustrated in the drawings. The computer systems, alternatively, can be implemented by hardware or other processing circuitry. The various functions of the computer systems can be distributed in a variety of manners among practically any quantity of computer or processing systems or circuitry and/or among practically any quantity of software and/or hardware units or modules. The software and/or algorithms described above and illustrated in the flow charts can be modified in a manner that accomplishes the functions described herein.

Connectivity between the GUI interface controller module and the GUI client can be implemented by practically any communications network (e.g., LAN, WAN, Internet, Intranet, etc.) or can be a communication connection internal to the GUI client. The GUI interface controller module server and GUI client computer systems can include any conventional or other communications devices to communicate over the network. The GUI control/user profile information store can be implemented by practically any quantity of conventional or other databases, storage units or structures (e.g., file, data structure, etc.), can be arranged in practically any fashion and can store practically any desired information. The GUI interface controller module, infopop monitoring module, GUI control / user profile information store and content/onset time processing module can be located on the same computer system, or partitioned in various manners across multiple systems.

The GUI interface controller module, including the accompanying GUI control / user profile information store, can be implemented by practically any quantity of computer systems, and can reside on a server, end-user or other third-party computer system or practically any combination of these computer systems. The GUI client can support any number of GUI displays in support of any number of applications. The GUI client, GUI interface controller model, infopop monitoring module, infopop content/onset time processing module, and GUI control/user profile information store can be stored on recorded medium (e.g., floppy diskettes, CD-ROM, memory devices, etc.) for loading on stand-alone systems or systems connected by a network, or can be downloaded (e.g., in the form of carrier waves, packets, etc.) to systems from a network. The GUI control/user profile information store, including user infopop activity log information, infopop definition information and user profile information, can be implemented using any information storage structures on any information storage device.

The present invention is not limited to the specific applications disclosed herein, but can be used in substantially the same manner described above to implement a graphical user interface that employs infopops with adaptive infopop onset times and adaptive infopop content.

Having described methods and apparatuses related to the operation and use of a graphical user interface that employs infopops with adaptive infopop onset times and adaptive infopop content, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in their ordinary and accustomed manner only, unless expressly defined differently herein, and not for purposes of limitation.

Trademarks

IBM® and DB2® are trademarks or registered trademarks of International Business Machines, Corporation in the United States and other countries. Microsoft® is a trademark or registered trademark of Microsoft® Corporation, in the United States and other countries. Macintosh® is a trademark or registered trademark of Apple Computer, Inc., in the United States and other countries.

What is claimed is:

1. A method of adaptively setting a time delay for controlling presentation of an information display area within a graphical user interface (GUI) operating on a computer, comprising:
monitoring information pertaining to a user's use of the computer;
setting a time delay parameter based upon the monitored information wherein the time delay parameter is for controlling the presentation of the information display area.

2. The method of claim 1, wherein the information display area is an infopop.

3. The method of claim 2, wherein the information monitored includes a number of instances that the infopop within the graphical user interface has been presented to a specific user.

4. The method of claim 3, wherein the information monitored includes for each said instance that the infopop was presented to said specific user an amount of time that the infopop remained presented on the GUI.

5. The method of claim 1, further comprising adaptively setting content presented in the information display area based upon the monitored information.

6. The method of claim 1, wherein the time delay is computed using the equation DT_{Total}=DT_{Initial}+DT_{Adaptive}, where the DT_{Total} is said time delay, the DT_{Initial} is a delay time for initially displaying the information display area to the user, and the DT_{Adaptive} is a value computed based upon monitored information.

7. The method of claim 6, wherein the DT_{Adaptive} is related to the number of times the information display area has been presented.

8. The method of claim 1, further comprising integrating the monitored information with a user behavioral profile and customizing the GUI based on an expertise level of the user indicated by the user behavioral profile.

9. An apparatus for adaptively setting a time delay for controlling presentation of an information display area within a graphical user interface, comprising:
a graphical user interface controller module configured to control the presentation of the information display area within the graphical user interface (GUI);
a monitoring module that receives information pertaining to the presentation of the information display area from the graphical user interface;
a data store module that stores information pertaining to the presentation of the information display area received from the monitoring module; and
a processing module that retrieves information pertaining to the presentation of the information display area from the data store module and sets a time delay parameter for the information display area.

10. The apparatus of claim 9, wherein the information display area is an infopop.

11. The apparatus of claim 10, wherein the processing module changes the content scheduled for the presentation via the infopop based upon content previously displayed.

12. The apparatus of claim 10, wherein the information stored includes a number of instances that the infopop has been presented to a specific user identity via the graphical user interface.

13. The apparatus of claim 9, wherein:
the data store module further stores user identity information pertaining to the presentation of the information display area; and
the processing module retrieves information pertaining to the presentation of the information display area that includes user identity information and calculates the delay period for the presentation of the information display area to a specific user identity.

14. The apparatus of claim 13, wherein the information stored includes for each instance that the information display area was presented to said specific user identity an amount of time that the information display area remained presented on the GUI.

15. The apparatus of claim 9, wherein the time delay is computed using the equation DT_{Total}=DT_{Initial}+DT_{Adaptive}, where the DT_{Total} is said time delay, the DT_{Initial} is a configurable initial default delay time, and the DT_{Adaptive} is a computed value based upon monitored information.

16. The apparatus of claim 15, wherein the DT_{Adaptive} is related to the number of times the information display area has been presented.

17. The apparatus of claim 15, wherein the DT_{Adaptive} is computed using the equation
$${DT}_{Adaptive} = C * ( n * n / {\sum }_{i = 1}^{n} t ( i ) ) ,$$
where the C is a configurable value set based upon the complexity of the information display area presented, n is the total number of instances the information display area has been presented to a unique user via the graphical user interface, and the t(i) is the amount of time that the information display area was presented during each said instance that the information display area was presented to said specific user.

18. An article of manufacture comprising a computer program carrier readable by a computer and embodying one or more instructions executable by the computer for adaptively setting a time delay for controlling presentation of an information display area within a graphical user interface, said computer program comprising:
program instructions for monitoring information pertaining to the presentation of the information display area within the graphical user interface (GUI); and
program instructions for setting a time delay parameter based upon the monitored information wherein the time delay parameter is for controlling the presentation of the information display area.

19. The article of manufacture of claim 18, wherein the information monitored includes a number of instances that the information display area within the graphical user interface has been presented to a specific user.

20. The article of manufacture of claim 19, wherein the information monitored includes for each said instance that the information display area was presented to said specific user an amount of time that the information display area remained presented on the GUI.
